(19) United States
(12) Patent Application Publication
(10) Pub. No.: US 2021/0304152 A1
(43) Pub. Date: Sep. 30, 2021

(54) RECRUITMENT AND NETWORKING MOBILE APPLICATION

(71) Applicant: EVRLINK, INC., Juno Beach, FL (US)

(72) Inventors: Joseph RUIZ, Huntington Beach, CA (US); Sean MORRISON, Juno Beach, FL (US)

(21) Appl. No.: 17/346,967

(22) Filed: Jun. 14, 2021

Related U.S. Application Data
(63) Continuation-in-part of application No. 16/282,041, filed on Feb. 21, 2019.
Application No. 16/282,041 is a continuation-in-part of application No. 15/839,603, filed on Dec. 12, 2017, now abandoned.
(60) Provisional application No. 62/550,519, filed on Aug. 25, 2017.

(51) Int. Cl. G06Q 10/10; G06Q 30/02; G06Q 50/00; H04W 4/029

(52) U.S. Cl. CPC G06Q 10/1053; G06Q 30/0214; H04W 4/029; G06Q 50/01; G06Q 30/0215

(57) ABSTRACT

A matchmaking and geolocation mobile software application is designed for recruiting and professional networking. The software application allows users to have jobs and resumes attached to their public profiles, which are displayed on a map for others to see, pursue and engage. The software application can include three primary screens for user information, a map view, a user view and a list view. Users can see who is around them and the application can prioritize showing other users who have something in common. People will be able to know information about who is around them at a coffee shop, conference, or networking event prior to engaging with them in real time. Users will be able to broadcast jobs they represent to those around them and will be able to represent that job anywhere they go within the map view.

### CROSS-REFERENCE TO RELATED APPLICATIONS

This application is a continuation-in-part of U.S. patent application Ser. No. 16/282,041, filed Feb. 21, 2019, which is a continuation-in-part of U.S. patent application Ser. No. 15/839,603, filed Dec. 12, 2017, which claims the benefit of U.S. Provisional Application No. 62/550,519 filed Aug. 25, 2017, the contents of each of which are herein incorporated by reference.

### BACKGROUND OF THE INVENTION

### 1. Field of the Invention

One or more embodiments of the invention relates generally to mobile software applications. More particularly, the invention relates to software, systems and methods for connecting job seekers with recruiters as well as connecting individuals in a professional networking environment.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Employers continue to struggle in finding talent for positions to help their businesses grow and achieve their business goals. Employers spend billions of dollars annually on recruitment advertising and related fees only to achieve nominal results. Additionally, professionals, especially hiring managers and recruiters, are often on the go and always looking for specialized talent.

From a professional networking standpoint, many professionals are disappointed with the quality of their connections. They struggle to build a network of like-minded professionals, or they struggle to find value in their existing network. What's more, many professionals simply do not have the time to attend networking events and conferences only to walk away with a handful of new connections that most likely do not align with their interests or their center of influence. Even when professionals have time to attend networking events and conferences, they do not know someone's occupation or the details of their professional background unless they start a conversation. However, often, one starts a conversation only to find out they don't have anything in common with the person or matching backgrounds.

While applications, such as LinkedIn, have revolutionized the professional networking and recruiting industry, many employers are still struggling to find talent to fill their jobs. Moreover, many professionals are disappointed with the quality of their connections or struggle to benefit from their current professional network on these conventional applications.

In view of the foregoing, it is clear that there is a need for a system and method for aligning professionals, especially job seekers and recruiters.

### SUMMARY OF THE INVENTION

The mobile software application, according to embodiments of the present invention, was designed to solve the foregoing problems by enabling hiring managers, recruiters and other professionals with the ability to search for, identify, connect with, and recruit specialized talent anywhere and anytime using a matchmaking and geolocation technology platform. Additionally, employers will be able to “outsource” their recruitment efforts by allowing users to publicly display their open jobs, giving the employer visibility to users' individual professional networks and visibility to other users physically around them, within a short but specified radius.

The mobile software application, according to embodiments of the present invention, was also designed to solve the foregoing problems by assisting people in creating and engaging with like-minded connections anywhere and in real time using the matchmaking and geolocation technology platform. The mobile software application may also provide optional assistance and recommendations on specific topics or information to inquire about when making the connection.

Embodiments of the present invention provide a method for advertising a job opportunity comprising populating a job database with the job opportunity; tracking a location of a job seeker by geolocation of a job seeker mobile computing device; displaying, via a mobile application stored on the job seeker mobile computing device, the job opportunity when the job opportunity is within a predefined distance from the job seeker; and displaying, on the job seeker mobile computing device, other users of the mobile application who are within the predefined distance from the job seeker, wherein the displaying of the job opportunity is selectable between a list view and a map view.

Embodiments of the present invention further provide a method for linking recruiters and job seekers comprising tracking a first location of the one or more job seekers of a mobile application by geolocation of a job seeker mobile computing device of each of the one or more job seekers; providing a map view on the job seeker mobile computing device, the map view providing a location of one or more job opportunities; notifying the job seeker of the one or more job opportunities within a predefined distance; and providing a bounty payment to a user of the mobile application when the user recommends the one or more job seekers to one of the one or more job opportunities and the one or more job seekers is hired.

Embodiments of the present invention also provide a method for linking recruiters and job seekers comprising populating a job database with a job opportunity; associating the job opportunity to one or more job ambassadors; providing a map view on the job seeker mobile computing device, the map view providing a location of one or more job opportunities; and providing a bounty payment to a user of the mobile application when the user recommends the one or more job seekers to one of the one or more job opportunities and the one or more job seekers is hired, wherein the user is selected from one of the one or more job ambassadors or the job seekers.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a schematic representation of two users at a predefined location using the software application according to an exemplary embodiment of the present invention;

FIG. 2 illustrates a schematic representation of a selection of menu options on a recruiter's mobile device running the software application according to an exemplary embodiment of the present invention;

FIG. 3 illustrates a schematic representation of a selection of menu options on a user's mobile device running the software application according to an exemplary embodiment of the present invention;

FIG. 4 illustrates various data transfer configurations available with the software application according to an exemplary embodiment of the present invention;

FIG. 5 illustrates various databases associates with the various data transfer configurations of FIG. 4, according to an exemplary embodiment of the present invention;

FIGS. 6A through 6C illustrate a flow chart describing the admin portal functionalities available in the software application of the present invention;

FIGS. 7A through 7C illustrate a flow chart describing the employer portal functionalities available in the software application of the present invention;

FIGS. 8A through 8B illustrate a flow chart describing a general software workflow according to an exemplary embodiment of the present invention;

FIGS. 9A through 9E illustrate a flow chart describing the user portal functionalities available in the software application of the present invention;

FIGS. 10 through 12 illustrate exemplary map views for users of a mobile application according to an exemplary embodiment of the present invention;

FIG. 13 illustrates a list view of jobs for users of a mobile application according to an exemplary embodiment of the present invention;

FIG. 14 illustrates a map and user view for users of a mobile application according to an exemplary embodiment of the present invention;

FIG. 15A illustrates a job seeker home page for users of a mobile application according to an exemplary embodiment of the present invention;

FIG. 15B illustrates how the bounty tracker and job tracker portions of the mobile application are turned off until a user registers;

FIG. 16A illustrates a registered user home page for users of a mobile application according to an exemplary embodiment of the present invention;

FIG. 16B illustrates how the bounty tracker and job tracker portions of the mobile application are available for registered users;

FIG. 17 illustrates a visitor home page for users of a mobile application according to an exemplary embodiment of the present invention;

FIG. 18 illustrates a bounty hunter page for users of a mobile application according to an exemplary embodiment of the present invention;

FIG. 19 illustrates a network page for users of a mobile application according to an exemplary embodiment of the present invention;

FIG. 20 illustrates a job seeker home page in a logged-out state;

FIG. 21 illustrates a job seeker home page in a logged-in state;

FIG. 22 illustrates a job seeker job listing page for users of a mobile application according to an exemplary embodiment of the present invention; and

FIGS. 23A and 23B illustrate an exemplary work flow summarizing embodiments of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

A “computer”, “computing device”, “mobile computing device” and the like may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CS S), Synchronized Multimedia Integration Language (SMIL), Wireless Markup Language (WML), Java., Jini., C, C++, Smalltalk, Python, Perl, UNIX Shell, Visual Basic or Visual Basic Script, Virtual Reality Markup Language (VRML), ColdFusion or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Web sites comprise a collection of connected, or otherwise related, webpages. The combination of all the web sites and their corresponding webpages on the Internet is generally known as the World Wide Web (WWW) or simply the Web.

The computer program instructions may be stored in a tangible computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM MQSeries technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, and the like.

Embodiments of the present invention may include apparatuses for performing the operations disclosed herein. An apparatus may be specially constructed for the desired purposes, or it may comprise a general-purpose device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

Broadly, embodiments of the present invention provide a matchmaking and geolocation mobile software application designed for recruiting and professional networking. The software application allows users to have jobs and resumes attached to their public profiles, which are displayed on a map for others to see, pursue and engage. The software application can include three primary screens for user information, a map view, a user view and a list view. Users can see who is around them, and the application can prioritize showing other users who have something in common. People will be able to know a lot about who is around them at a coffee shop, conference, or networking event prior to engaging with them in real time. Users will also be able to broadcast jobs they represent to those around them and will be able to represent that job anywhere they go within the map view. A toggle can be provided to display people or jobs on the map view that lets other users see not only who is around them, but what jobs are around them. By touching a particular job, the user is able to learn more about the job and the individual representing that job.

The mobile software application can be used as a recruitment tool for employers and recruiters, allowing them to identify, connect with, and recruit specialized professionals anywhere and in real time. These connections can be made anywhere professionals congregate, including conferences, networking events, business parks, college campuses, coffee shops, sports venues, and the like. Additionally, users can attach job descriptions and advertisements to their public profiles which follow them wherever they go and will be displayed on a map view. As the user moves around to different locations, other users within a certain radius will be notified of the job and have the option to apply for the job or connect with the user who has the job. For example, a user can be at a conference and have several jobs on virtual display so other users around him or her can see the jobs and make contact. In some embodiments, a bounty may be offered by the employer to encourage professionals to distribute jobs to colleagues. When a referred colleague is hired, the professional referring the candidate can be paid the bounty that is described in the job posting.

Embodiments of the present invention further include a website with a mobile user interface that allows employers and individual users to manage their job postings, resumes and other content through any and all users in areas of their choosing in real time. The website, along with the various components of the mobile application, can work in unison to allow for real time networking and representation of jobs by any given user based on their location in a way that has never been done before.

Embodiments of the present invention can generate a unique URL for each member, where the members can upload content, such as job descriptions, resumes or other media that can be shared with other users. These member pages can include links to the user's social media pages. Users can customize their web pages to create personal branding platforms.

In some embodiments, a recruiter can upload a job to their profile and other users can include certain jobs to be attached to their profile. In this manner, not only does the recruiter broadcast the job opportunity, but other users can act as mobile job boards, allowing employers to access myriad talent pools and professional networks that were untapped by anyone, except for that individual user. In this manner, users can leverage, engage and monetize their professional networks using the matchmaking and geolocation technology platform of the present invention.

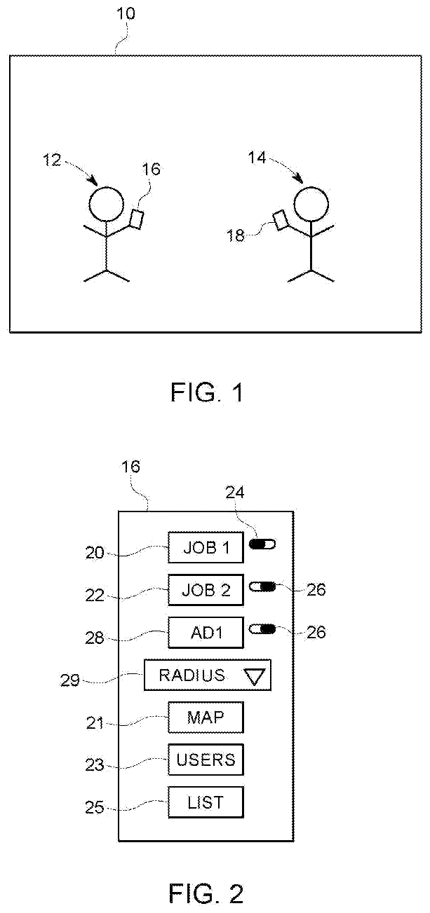

FIG. 1 illustrates a particular location 10 where people, such as a first user 12 and a second user 14 may congregate. The location 10 may include a coffee shop, a conference, a job fair, a networking activity or the like. Each user 12, 14 may have a mobile computing device 16, 18 running a mobile application software, also referred to as application software, software, or simply, application. The application may be configured to provide matchmaking and geolocation for recruiting and professional networking, as described in greater detail below.

In some embodiments, the user 12 may be a recruiter who has one or more jobs they seek to fill. As used herein, the term “recruiter” is meant as a generic term to describe any person who has a job to fill. The recruiter could be a human resources employee for a company with a job opening, a headhunter seeking candidates to fill openings, or an employee representing a company with a job opening.

As shown in FIG. 2, the mobile computing device 16 of user 12, who, in this case, is a recruiter, can run a software application that provides the opportunity to post jobs, such as a first job 20 and a second job 22, as well as advertisements 28, which may be a description of the user's company, products, services, or the like. If the user 12 clicks into the first job 20, for example, the user may be prompted to populate data describing the job, skills required, optional skills needed, or the like.

The software application may include toggles 24, 26 to permit turning on and off the broadcasting of a particular job or advertisement. For example, toggle 24 may indicate that the first job 20 is turned off from being broadcast, but the second job 22 and the advertisement 28 is turned on and broadcast. In some embodiments, the software application may permit the broadcast to other users within a particular radius. In some embodiments, a radius drop down 29 may be used to select this particular radius. Thus, user 12, acting as a recruiter, can broadcast the second job 22 to users within a particular radius. Other users, such as user 14 (see FIG. 1), if within the radius selected by user 12, may be able to view the second job 22, apply for the job, or even find the location of the user 12 on a map view to arrange a meeting, in real time, with the recruiter. In some embodiments, the software application may include provisions for broadcasting the job only during particular hours.

Accordingly, the software application of the present invention is able to broadcast a job posted by a recruiter and allow job seekers, within a particular radius of the recruiter, to contact the recruiter using geolocation technology to locate the recruiter. The software application can further include the ability to permit the job seeker to apply to the job, contact the recruiter via text message, email, interactive chat, or the like.

As discussed above, and referring to FIGS. 1 through 3, the software application may include a map view, accessible, for example, via a map button 21, 38 on the mobile device 16, 18. This view will allow users, such as job seekers, within the selected radius, to view jobs on a map. The user may click on a contact button 36, for example, for the job to get details of the job and to permit the job seeker to receive the location of the recruiter. The job seeker may apply for the job via an apply button 34, for example, or the job seeker can approach the recruiter, in real time, to discuss the job opportunity based on having the location of the recruiter via the software application.

The map view may include a toggle to move between viewing jobs on the map to viewing other users on the map. The user may then press on a particular user on the map to learn details of the user to determine if their interests may align before approaching the user. Details of the map view are described in greater detail below.

Similarly, the mobile device 16, 18 may include a “users” button 23, 37 to allow the user to view a list of other users within a predefined radius. As used herein, the term “predefined radius” may be any predefined perimeter whose boundaries may be not only circular but can be limited to a particular location or any user-defined or predefined boundary.

The software application may include a matching feature to automatically determine if interests between the user and others within the predefine radius have similar interest via, for example, profile keyword matching. In some embodiments, the software application may display the users sorted by distance away, by percent matching, or the like. Regardless of display method, a user may click on another user to view their profile and determine their location, permitting like-minded professionals to easily make a connection.

The software application of the present invention can save time for individuals at various types of gatherings by allowing users to see details of a job and/or another user before approaching the recruiter and/or other user to discuss the job or a particular subject of mutual interest. For example, prior to the software application of the present invention, at a job fair, job seekers may speak to recruiters at various booths of various companies without knowing if that particular recruiter has a job opening that may be a suitable fit. With the software application of the present invention, a user can scan jobs available and approach only those recruiters that have jobs available that match the job seeker's interest and skills set. This saves the time of not only the job seeker, but also the recruiter, making the job fair more successful and efficient.

As another example, prior to the present invention, a professional may approach another individual at a conference based on, for example, their mutual presence at a particular discussion. Even though they are present at the same conference, the professional cannot be sure there are any shared interests with the other individual until a discussion is initiated. However, with the software application of the present invention, the professional can determine other individuals that have mutual interests and engage in conversation with the knowledge that their interests align.

While the above focused on job seekers and their ability to approach recruiters who have jobs of interest posted to their profile, a job seeker may keep a resume 30, or other information, on their mobile device 18 and can use a toggle 32, or other function, to permit the information in the resume to be transmitted within a defined radius. Recruiters may see these resumes and approach job seekers should their interests align.

In some embodiments, the user 14 may view a particular job they may not want to apply for themselves, but the user 14 knows that other professionals that are linked to his or her profile may be interested in the job. In this case, the user 14 may attach that particular job to his or her profile and broadcast the job. This would allow other users, within a predefined radius of user 14, to view the job, contact the recruiter, apply for the job, or the like. Thus, not only are the recruiters able to broadcast the job opportunity, but other users may also broadcast the job, acting as mobile job boards, thereby providing details of the job opportunity to users previously unavailable to the recruiter. As described in greater detail below, a bounty may be paid to such users 14 when then refer other users to apply for a job and that other user is hired.

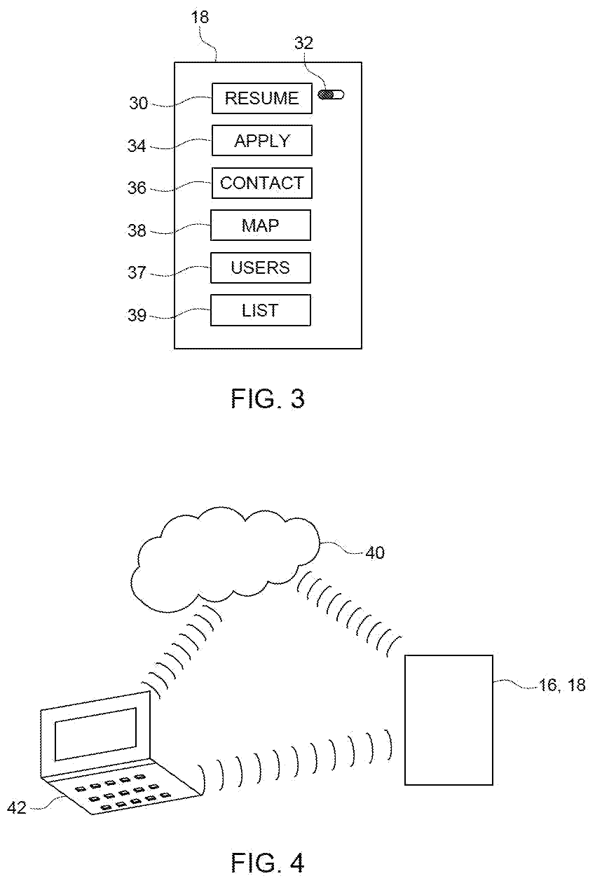

While FIGS. 2 and 3 show various buttons on the mobile devices 16, 18, these buttons are merely shown as a schematic representation, where the graphical user interface provided by the software application can be designed to provide a user-friendly format for recruiters, job seekers and other professionals to easily access and use the various features discussed herein. For example, the various functions of the software application may be menu driven and accessible from a map view, a list view of a user view.

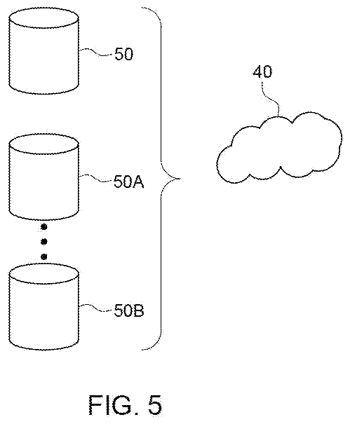

Referring to FIGS. 4 and 5, a server, such as a cloud server 40 may communicate with the mobile devices 16, 18 over any convenient wireless protocol. In some embodiments, a website may be provided for user access from any computing device 42. A user may sign in to a website via the computing device 42 and manage their job postings, resumes and other content. The server 40 can include various databases 50, 50A, 50B that store user information, access information, job opening information, or the like. Various technology may be used to organize data and information within the scope of the present invention. For example, each user may be assigned a unique URL as a personal website, wherein they can upload content, such as job descriptions, resumes or other media that can be shared with other users. Each of the databases 50, 50A, 50B may store each user's web content, for example, and provide for matching of user information to provide matchmaking results to users within a predefined radius.

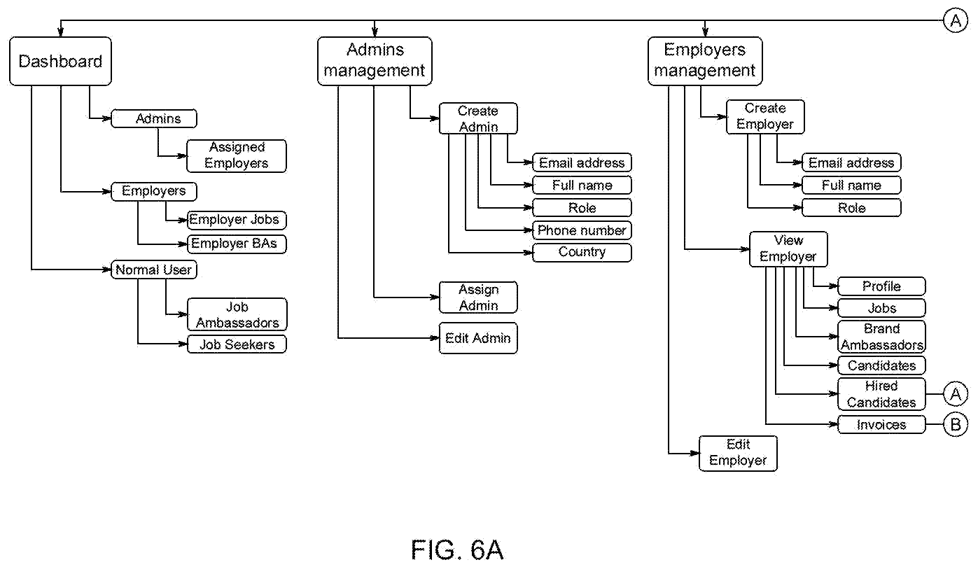

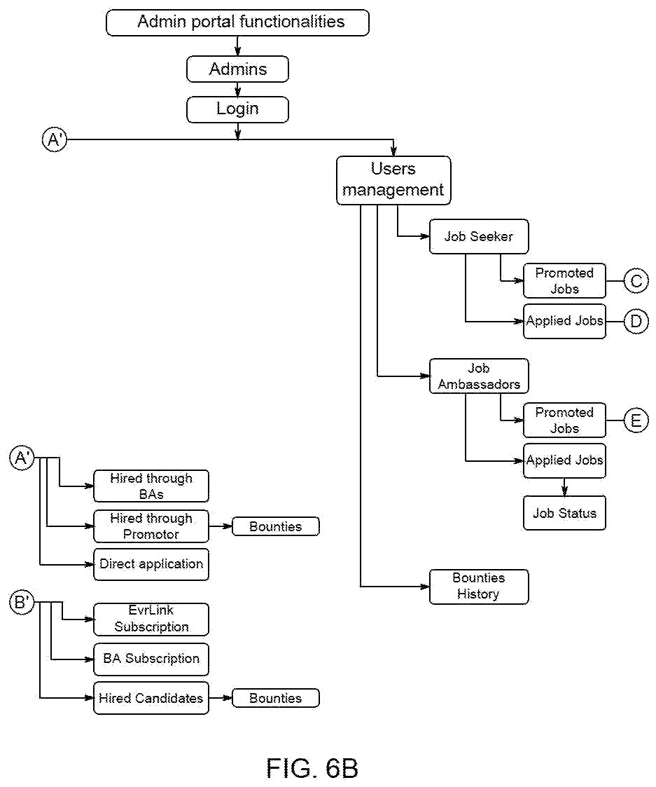

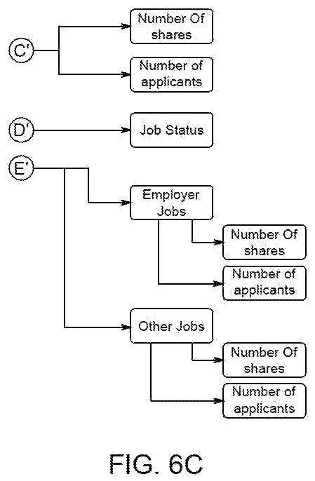

The software application can be accessed by different types of users, including super admins, admins, employers, brand ambassadors and job seekers (candidates). The below, in reference to FIGS. 6A through 9E explains, in a more detailed way, what are the roles of each type of user are, their access into the portal and their impact on the software application. It should be noted that each of the various roles shown in the flow charts described in FIGS. 6A through 9E can be carried out by the software application in various embodiments of the present invention.

Referring to FIGS. 6A through 6C, a workflow is provided that describes the admins and/or super admins roles within the software application. The super admin is the type of user who has full access to the administration section. Super admins are able to login into the admin portal using pre-created credentials. The features that the super admin can access include the dashboard, admins management, employers management and users management.

Within the dashboard, as shown in FIG. 6A, the super admin can see a graphic representation of all the other features: admins, employers (with their jobs and brand ambassadors) and normal users (candidates). Accessing any type of info in the dashboard can redirect the super admin to the specific feature in the portal.

Within the admins management feature shown in FIG. 6A, the super admins is able to create accounts for other admins and assign employers to them to limit their access into the portal, meaning they can only see details related to the employers to which they have been assigned. In order to create an admin account, the super admin typically has to provide the following details: full name, email, phone number, country, role, or the like. Also, super admins can edit admin details, except their email address and assign them to employers.

Within the employers management feature shown in FIGS. 6A and 6B, the super admin can create employer accounts—including email and password, view employers, view employer jobs, view employer ambassadors, view employers hired candidates, view employers invoices and the like.

Within the users management feature shown in FIGS. 6B and 6C, the super admin can (1) see a list with all the users with a) jobs they shared/promoted (number of shares and how many applied) and b) jobs they applied to; (2) see a list with all the users that need to be paid, including a) jobs they shared—with job details, b) applicants to the jobs they shared, c) hired through the software application, d) view bank account, e) process payment—send invoice and f) contact user—all contact info is displayed and admin can email them through portal; and (3) see bounties history by displaying previous bounties.

The admin is the type of user who can be assigned by the super admin to some of the employers. Admins will have access to all the features detailed above but can administrate only the employers that they've been assigned.

The employer is the type of user who can add jobs into the network created by the software application of the present invention and request to add Brand Ambassadors (BA's) to their account to promote their jobs by direct interactions in the software application.

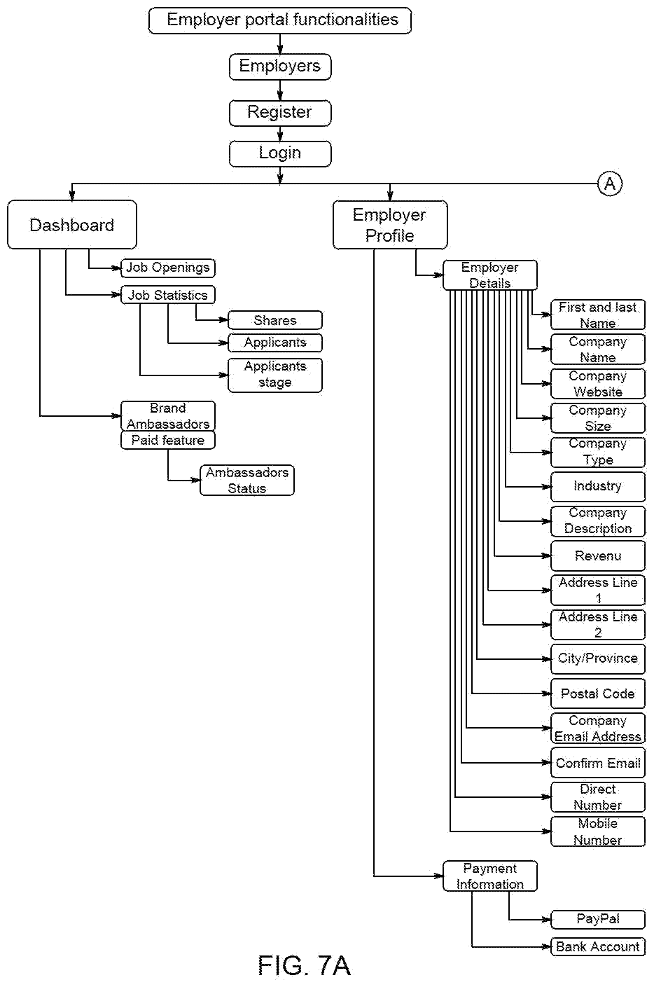

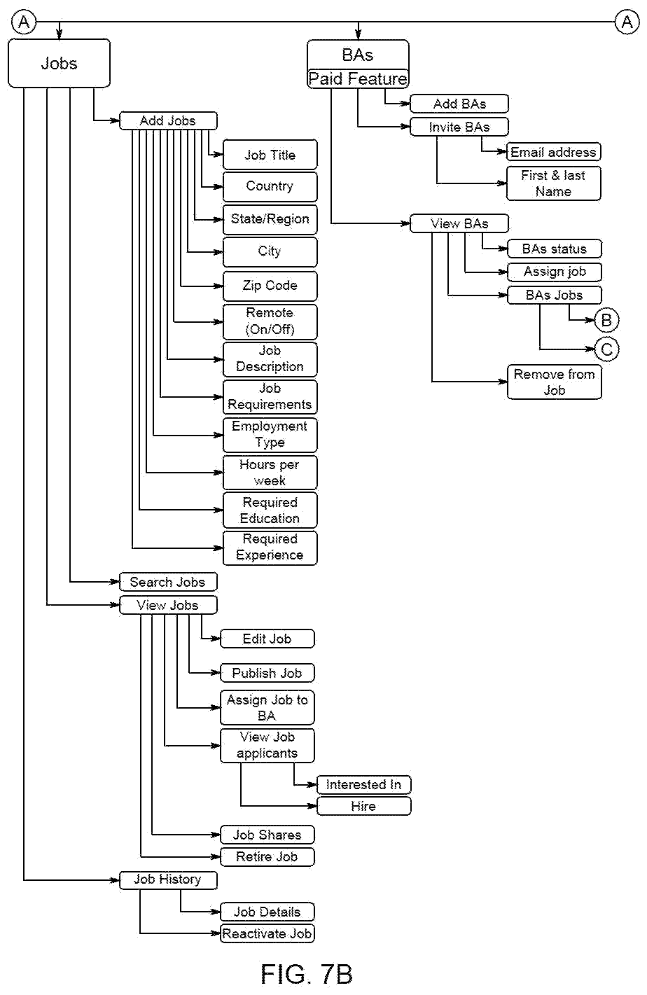

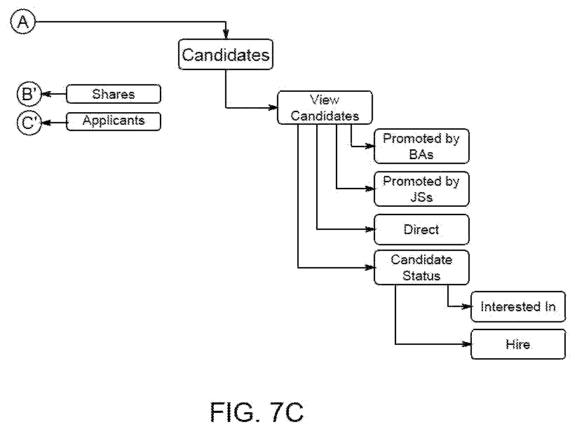

As shown in FIGS. 7A through 7C, the employer is able to access the following features: dashboard; jobs; brand/job ambassadors; and candidates Employer accounts can be created by, for example, super admins, employers, login with social media account, or the like. In order to create an account and have full access to the portal, the employer would need to provide the details, such as employer first and last name, company name, company website, company size, company type, industry, company description, revenue, address line 1, address line 2, city/province, postal code, company email address, confirm company email address, direct number/landline, mobile number and payment information, for example.

The employer may be allowed to create an account and access the portal using only the company email and pasword, but will not be able to post jobs until all the above details are provided.

As shown in FIG. 7A, in the dashboard, the employer will be able to see the following information: (1) Job Openings, wherein the employer can view jobs and redirect to the jobs feature where he can edit, add or remove jobs. The employer is able to see how many jobs have been posted (Status=Active) and how many jobs have been removed (Status=Retired). If jobs are or have been assigned to a Job/Brand Ambassador, the user will be able to see that too. (2) Job Statistics, wherein the employer can view the people who applied to the jobs (without name or contact details—if it's direct applicant) and the stage they are in: applied, interested in or hired, which can also redirect the user to the candidates feature. (3) Job Ambassadors, where the employer can view a number of Job Ambassadors for every employer. The above are presented briefly in the dashboard, in, for example, a Google® Analytics type of graphic representation so the employer can filter them by the desired period of time.

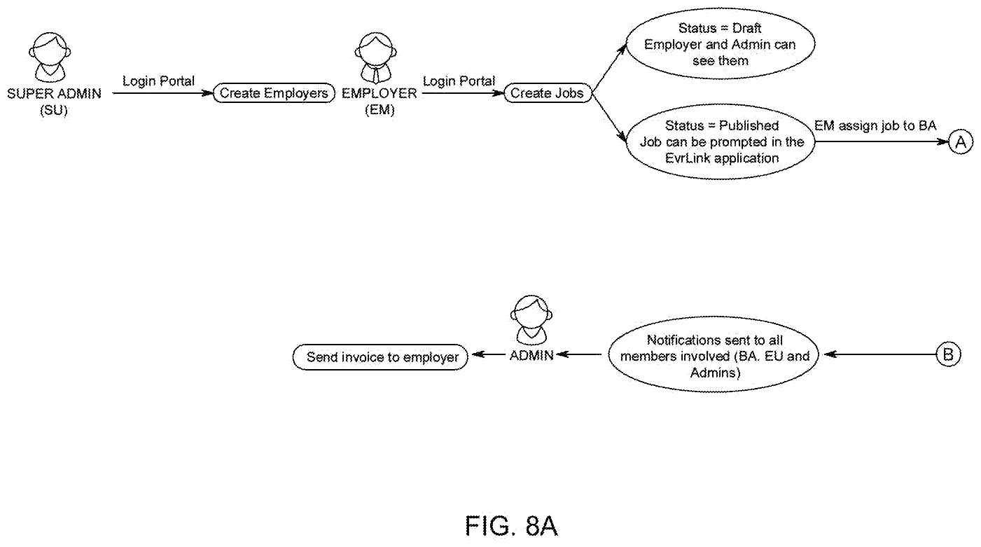

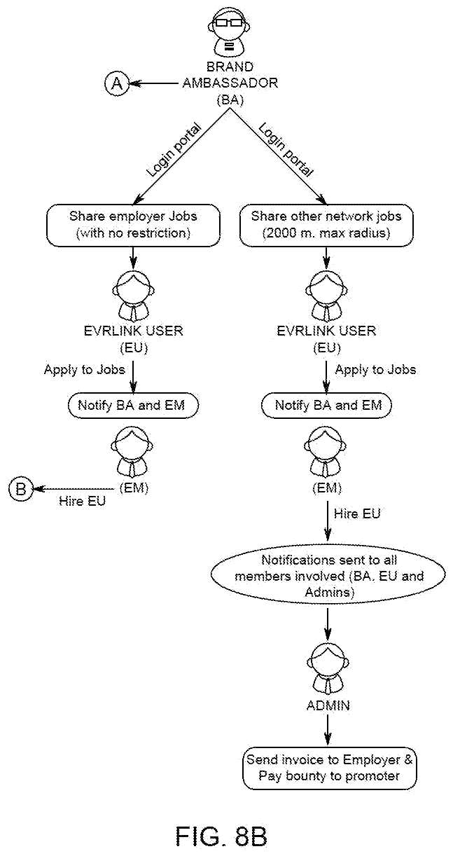

As shown in FIG. 7B, using the jobs feature, the employer can add, edit or remove jobs. An employer is able to post jobs typically only when he has a full profile. This means that the employer will have to provide full details about the company, in the employer profile section (see FIG. 7A). In order to add a job, the employer will have to provide the following details: (1) mandatory details, including job title, country, state/region, city, zip code, remote (toggle on/off), job description—text, job requirements—text and employment type, such as full-time, part-time, temporary, contract, internship or the like; and (2) optional details, such as hours per week, required education, required experience and job statuses. Employers will be able to create jobs and keep them as drafts (job status=draft) so the jobs will not be displayed on the map provided by the software application. When desired, the employer cand change that status to publish (job status=published) and the jobs will appear on the map. FIG. 8A shows where such options are provided to the employer.

The job can be retired at any time (job status=retired). In this case, the jobs will be removed from the map and candidates will not be able to apply to them anymore.

Employers can view a job history. This job history will show every job detail, job status and job candidates. Employers can reactivate any retired job and republish them.

Employers can assign jobs to all ambassadors or select which ambassador can promote certain jobs.

Employers can add Job/Brand Ambassadors to their account to help them promote their jobs. In order to have access to this feature, employers may have to pay a monthly fee depending on how many ambassadors they want to have. To add Job/Brand Ambassadors, employers can type an email address/name and the portal will autocomplete the search with an existing user, or create a new account. When creating a new account, the employer has to type an email address and an invitation will be sent with the status pending (invitation status=pending). When the invitation is accepted, the employer will be notified and the status will change to accepted.

Employers can view Job Ambassador profiles and jobs they are currently promoting. The job ambassador and jobs relation is a many-to-many type of relation.

Referring to FIG. 7C, in the Candidates feature, the employer will be able to see (1) Candidates to jobs that have been promoted by Job Ambassadors; (2) Candidates to jobs that have been promoted by normal users; and (3) Direct candidates.

Candidates will also have statuses, such as (a) applied—candidate applied to the job; (b) interested in—candidate presents interest and will be reviewed by the employer; or (c) hired—candidate was hired. In some embodiments, the software application will inform the admin that the employer is interested in that specific candidate and the hired step will send out an invoce to the employer.

For candidates to jobs that have been promoted by Job Ambassadors, the employer can see the full profile (contact details, user details) and Resume/CV. Thus, the employer can see the candidate's full profile. For candidates to jobs that have been promoted by normal users, the employer may not be able to view the contact details. The only details that the employer can typically see are education, experience (job history), skills and interest. When the Employer moves the candidate to interested in, this will notify the admin that the employer is interested in his application and the portal will also display full contact details and also the Resume/CV. If the employer chooses to hire this type of candidate, the invoice will be sent out to the employer and software application can send a bounty to the user who promoted the job.

For direct candidates, the employer can see only education, experience, skills and interests. When the candidate is moved to the interested in step, the admin is notified and the portal displays the rest of the candidate's information. Hiring this type of candidate will send out an invoice to the employer.

The Job/Brand Ambassador type of user will act like a job seeker (candidate), but it will also help the employer to promote jobs in the network by direct interactions with the job seekers (candidates).

The job ambassador is able to access the following features: profile, dashboard, jobs, connections, suggested users, suggested candidates, calendar, contacts, settings and map view

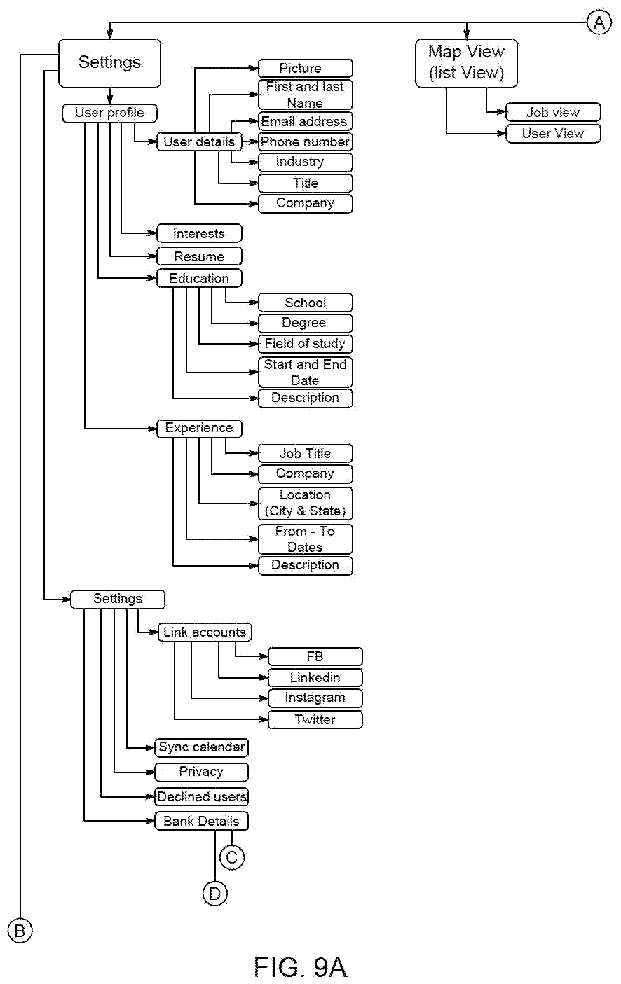

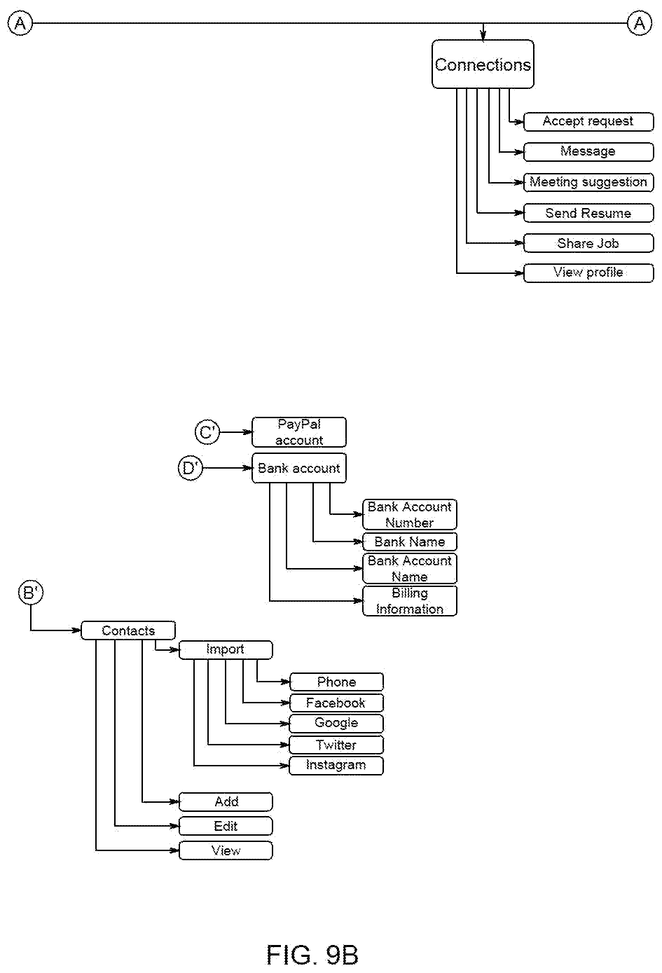

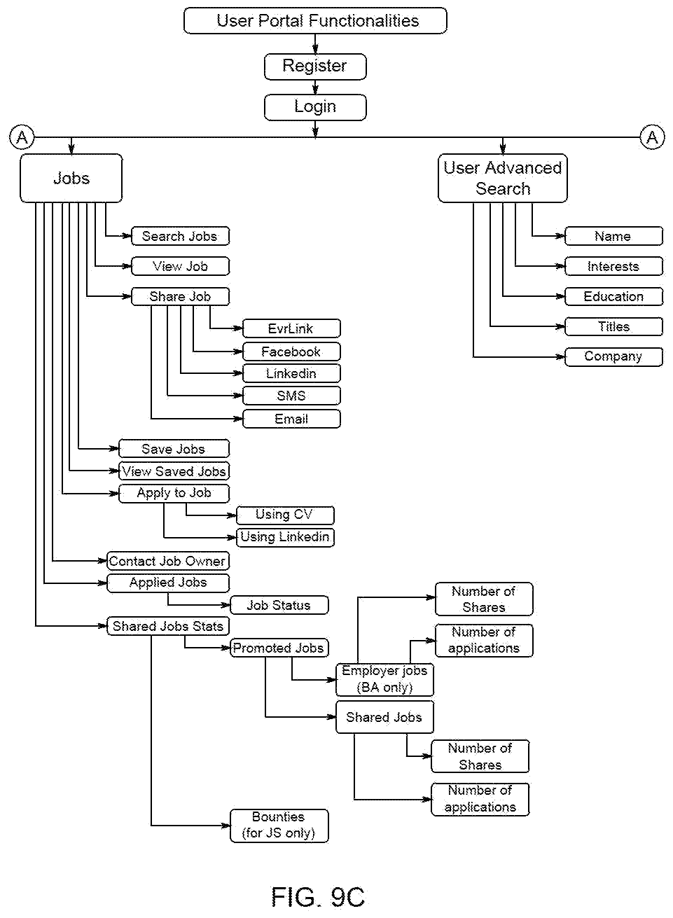

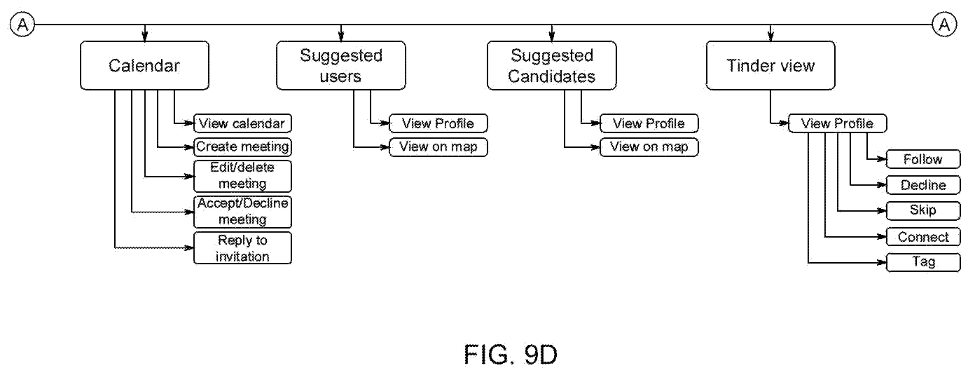

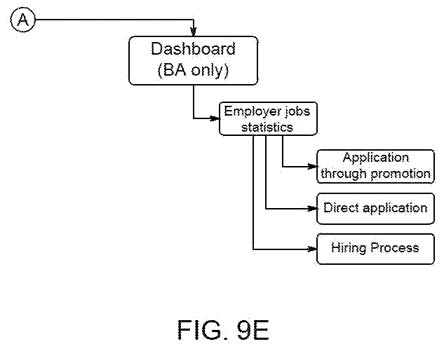

Many of the functionalities of the job ambassador follow those of the user, as described relative to FIGS. 9A through 9E, discussed below.

In the dashboard, job ambassador can see a breakdown description of the employer jobs (job statistics), such as who applied through promotion and who applied by themselves, and hiring process steps (similar view with the employers) based on their statistics.

In the jobs section, the ambassador can see employer jobs (that have been assigned to him)—priority (can promote through the whole Network, not radius restricted), shared jobs—jobs that have been shared with other users (with statuses), other jobs—can promote in a max 2000 meters radius (like a normal user), for example, and applied jobs—the job ambassador can apply to jobs, exactly like a normal user and can see the applied jobs.

In some embodiments, if a user applies to a job that the ambassador promoted, the match functionality will be skipped and the user and ambassador can directly chat with each other. If a user is in near proximity, such as within 2000 meters maximum, jobs can be shared/promoted through various networks, email, social media or the like.

Users will be able to communicate with all their matches—connections made between software application users when the other users also matched. Tapping on a user from this list will open a chat screen that will also have the following options view profile, ping, unmatch, delete messages and the like.

A suggested users screen allows the user to see a list with other software application users around him with a similar interest or education. From this list, the user can access their profile or view them on the map.

A suggested candidates screen will allow the ambassadors to see a list with users that have similar interests or skill sets to the jobs they are promoting. From this list, the user can access their profile or view them on the map.

A calendar can display the current month with highlighted days where a meeting is set. The current day may also be highlighted. Here, the user can view the list of all meetings and add meetings. In the list of meetings, the user is able to access requests—all meetings requests received from other users (matches) that can be accepted or declined, and meetings—all the meetings including the ones sent by him. The type of meeting, such as pending, accepted, declined or canceled may be indicated on the calendar.

In the software application and portal, the ambassador will be able to sync calendars, set notifications for candidates ON/OFF (default to On), set notifications for recommendation (suggestions) ON/OFF (default to On), view users in radius—max 2000 meters, for example, and share jobs in a predefined radius, such as 2000 meters.

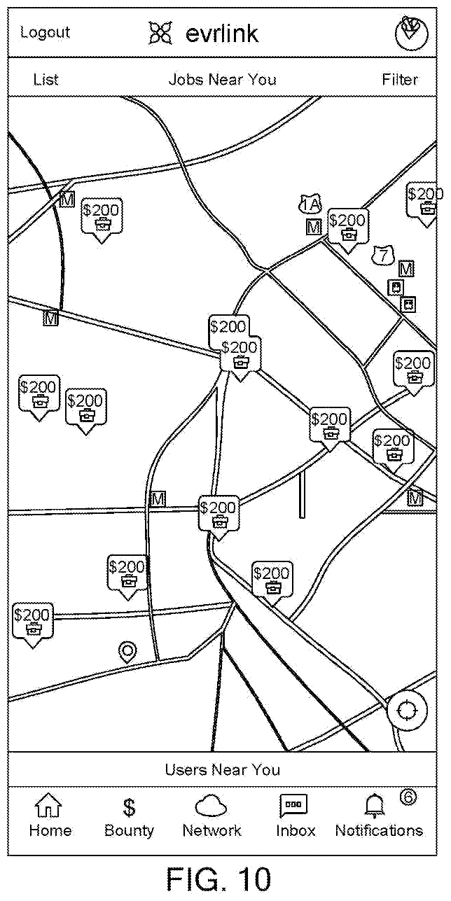

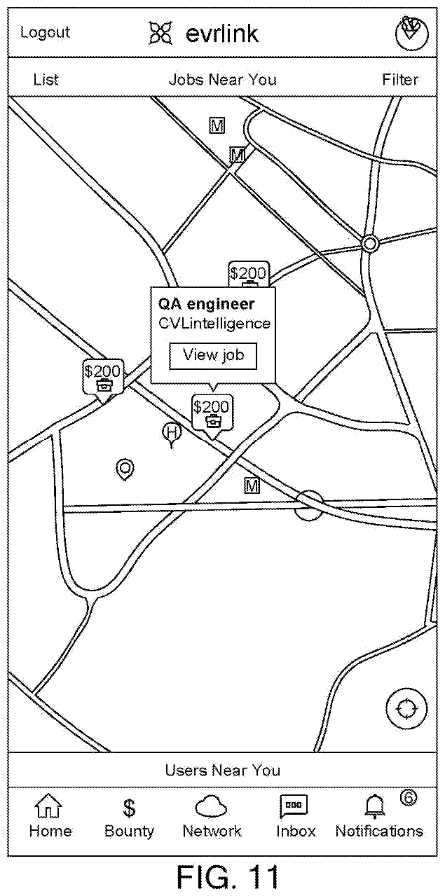

Referring to FIGS. 10 through 14, jobs can be viewed on the map by tapping the Job icon from the map and switching views. Users will be able to see on the map and in the Jobs list view all the available jobs. Tapping on a job, will display the following, for example, job details, job actions (such as pass, share, apply, contact ambassador, save, or the like), and shared jobs. In some embodiments, the jobs will include a bounty amount associated with each job, such a $200 as shown in FIG. 10, for example. This bounty may be payable to a user of the application if that user recommends someone for a particular job and that person applies for the job and is hired. A bounty may also be payable to a user when the user associates the job opportunity with their profile. In this manner, users are motivated to promote jobs to others, while the companies are matched with professionals without the need for other recruiting efforts and/or costs.

In some embodiments, when viewing jobs on the map view, if the user is a job or brand ambassador, those jobs assigned to him or her may be in a color different from other jobs. As a brand ambassador, the user may be offered an additional bounty or other incentive to promote those particular jobs assigned to them.

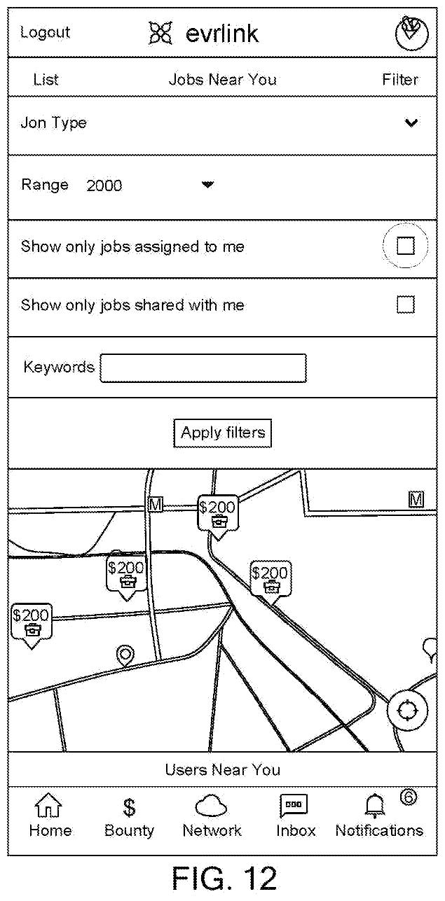

FIG. 12 shows examples of filters that may be applied to one's job search, including job type, range, showing only jobs assigned to that user, showing only jobs shared with that user, keywords, or the like.

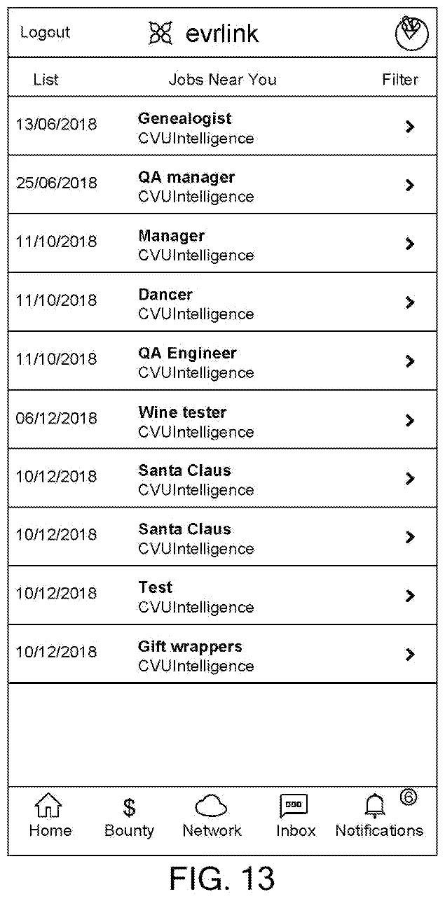

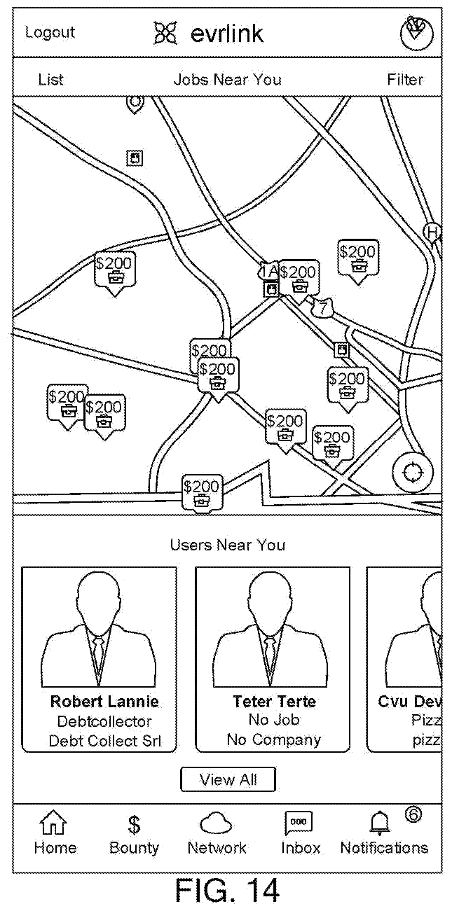

As shown in FIG. 13, the jobs may be shown as a list instead of on a map. Moreover, as shown in FIG. 14, a users near you page may be used to identify those users nearby the current application user, as discussed above.

When a user choses to share/promote a job to a different user, a link will be sent to that user and the job itself will be displayed on the Promoter's Shared Jobs Screen with status Pending. When the User clicks/taps on the received link, the job will open up with the possibility to apply to it or save it. If the User applies for the job, the job status will be changed to Applied so to inform the User that the recommended person applied to the job.

Applying to a recommended job will trigger the following actions: (1) In the promoter's Shared jobs screen, the Job status will change from Pending to Applied; and (2) The Job Ambassador will be notified and be able to chat with the candidate.

When the Employer is interested in the candidate, a notification will be sent to all Users, informing them that the application will be reviewed.

When the candidate is hired, a notification will be sent to all Users.

In Users view, the User will be able to see users around him: Job Seekers/Promoters or Job Ambassadors (max 2000 meters, for example). All the Users available on the map will also be displayed in the Users list view where they can be searched by name, company or title. In the List view, the User has 2 options: View on Map or Show profile. Also, in the List view, the User has the possibility of seeing Tagged Users which are users that have been tagged from the initial User list in order to avoid searching for them again.

The Job Seeker is able to view the map with his updated location. On the map, he can choose to see Users or Jobs around him. When in the Map View, Users will also be able to set themselves Available (green dot) or Busy (red dot) and add a status.

The Job Seeker is the type of User who's going to be able to search for jobs that have been previously added by the Employers and are promoted by the Job Ambassadors, through the mobile application. Also, the Job Seeker will be able to get a portal account where he can make changes to his personal information.

Any details that are edited in the portal will take effect on the mobile application as well and vice versa.

When accessing the mobile application and portal, the Candidate has 2 possibiltiies: a) create an account; orb) login using social media account.

If the User chooses to create an account, he will have to provide the following information: first name, last name, e-mail, password & confirm password (min 6 characters that have to match), job title, business field and company. All these fields may be mandatory. When all the details have been provided, the User will be allowed to create an account and he will be redirected to his profile.

If the User chooses to login with a social media account, the software application will ask permission to gather information from that account. If permission is granted, the User will be redirected to the register screen with some of the fields already filled (that can be retrieved from the social media account used to log in). The User will be able to edit those fields and create an account when all the mandatory information is provided.

As shown in FIGS. 9A through 9E, the job seeker is able to access the following features:

1. Profile, 2. Connections, 3. Settings, 4. Jobs, 5. Suggested Users, 6. Suggested Jobs, 7. Calendar, 8. Contacts and 9. Map View.

After creating the account, the User will be redirected to his profile that's divided into 1. general information, education, school (mandatory, autocomplete), degree, field of study, start and end date and description; 2. skills—skill name; 3. interests—interests list; 4. resume—upload PDF or Word file, for example; 5. Experience; 6. Social networks link connections; and 7. Bank details.

Users will be able to communicate here with all their matches—connections made between software application Users when the other users also matched. Tapping on a User from this list will open a chat screen that will also have the following options: view profile, ping, unmatch and delete messages.

In the mobile application, the User will be able to sync calendars, view users in selected radius, view users from selected industries (autocomplete), select wo can view his profile—industries, set CV Privacy, set decline period for declined users and view declined users.

Suggested Users screen allows the User to see a list with other software application Users around him with a similar interest or education. From this list, the User can access their profile or view them on the map.

Suggested Jobs screen allows the User to see a list of Jobs around him that match or are similar with the User's interests, skills or education. From this list, the User can access the jobs and see jobs details. Users will be able to share jobs only with 1. Users that are in a 2 km radius; or 2. Connections.

The calendar displays the current month with highlighted days where a meeting is set. The current day may also be highlighted. Here, the User can view the list of all meetings and add meetings. In the list of meetings, the User is able to access: Requests—all meetings requests received from other users (matches) that can be accepted or declined; and Meetings—all the meetings including the ones sent by him.

In the Contacts section, the Job Seeker will be able to import contacts (device, Google, Facebook, LinkedIn, Instagram, Twitter, or the like), view available contacts, view all contacts or add contact manually.

Jobs can view on the map by tapping the Job icon from the map and switching views. Users will be able to see on the map and in the Jobs list view all the available jobs. Tapping on a job, will display the following: (1) Job details, (2) job actions; and (3) shared jobs.

When a user chooses to share/promote a job to a different User, a link will be sent to that User and the job itself will be displayed on the Promoter's Shared Jobs Screen with status Pending. When the User clicks/taps on the received link, the job will open up with the possibility to apply to it or save it. If the User applies for the job, the job status will be changed to Applied so to inform the User that the recommended person applied to the job.

Applying to a recommended job will trigger the following actions: (1) In the promoter's Shared jobs screen, the Job status will change from Pending to Applied; and (2) The user will receive a notification.

When the Employer is interested in the candidate, a notification will be sent to all Users, informing them that the application will be reviewed. When the candidate is hired, a notification will be sent to all Users, and the User who promoted the job will receive a bounty.

In Users view for the map section, the User will be able to see users around him: Job Seekers/Promoters or Job Ambassadors (max 2000 meters). All the Users available on the map will also be displayed in the Users list view where they can be searched by name, company or title. In the List view, the User has 2 options: View on Map or Show profile.

Also, in the List view, the User has the possibility of seeing Tagged Users which are users that have been tagged from the initial User list in order to avoid searching for them again.

The Job Seeker is able to view the map with his updated location. On the map, he can choose to see Users or Jobs around him. When in the Map View, Users will also be able to set themselves Available (green dot) or Busy (red dot) and add a status.

User appears on the map an can be contacted in the application. The User can receive match request, the User can be declined, the User can be Tagged, the User can View Resume, or the User can view jobs (if he's a Job Ambassador)

Busy actions can include where the Users can be tagged (added to the tagged list) or declined (removed from the map/user list), but will receive them only when he becomes available. If a User is Offline, he will have a grey dot, for example. If a User is a Match, he will have a blue dot, for example.

In the view user profile, tapping on the User will display the following: (1) User Profile (2) Posted Jobs; and (3) Tag User—to add to the Tagged Users list and view later.

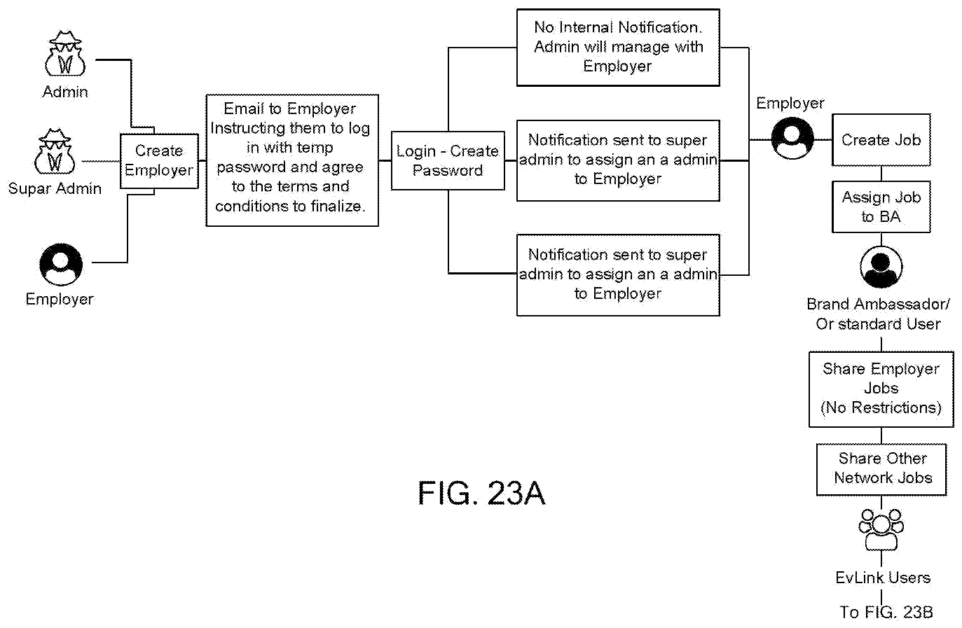

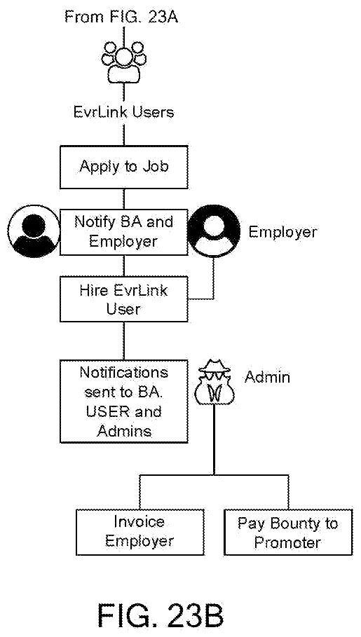

The above workflows provided in FIGS. 7A through 9E are merely exemplary of embodiments of the present invention. The workflows may differ and may include other features as contemplated by one skilled in the art. For example, the workflow of FIGS. 23A and 23B summarize a general workflow, from employer, to brand ambassadors, to application users (EvrLink users).

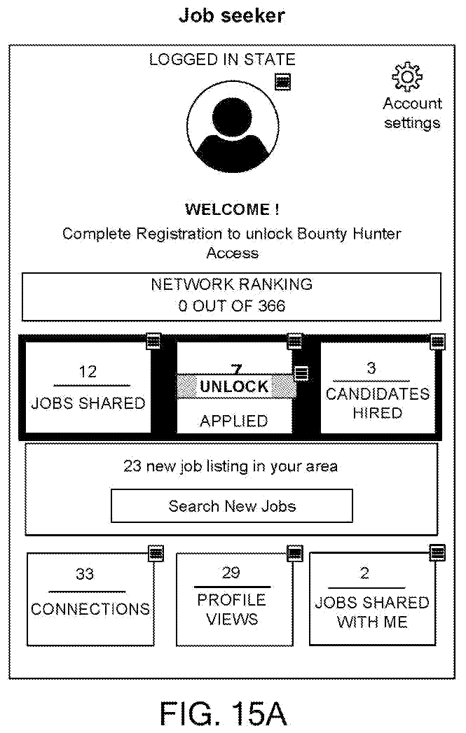

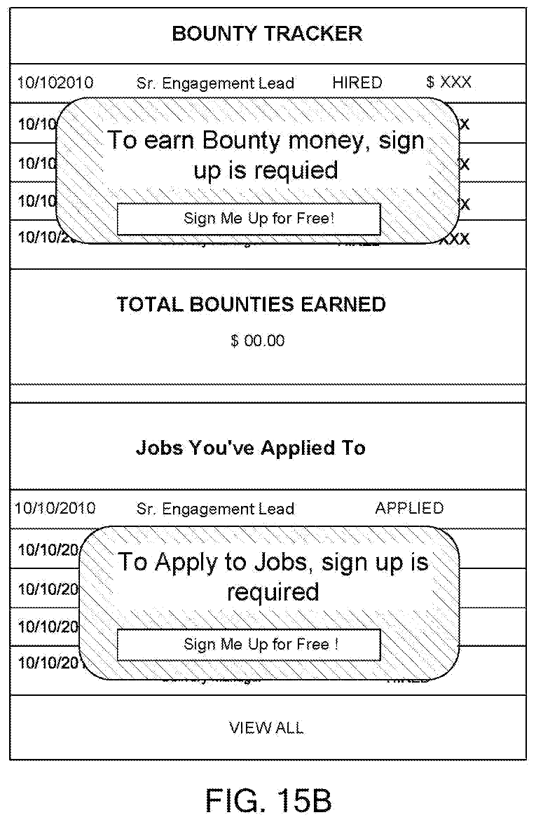

Referring to FIGS. 15A and 15B, a user may be assigned “Job Seeker” status by installing the application and providing details about themselves. Typically, as a job seeker, the user may have access to the map views, as discussed above, to view the available jobs, as well as the ability to set up a profile, make connections, and the like. However, as shown in FIG. 15B, the job seeker user may not have access to the bounty tracker. A job seeker can register as a registered user to access additional features.

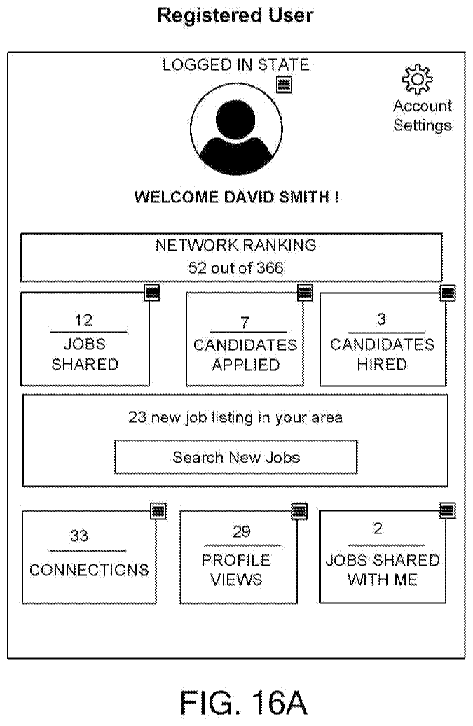

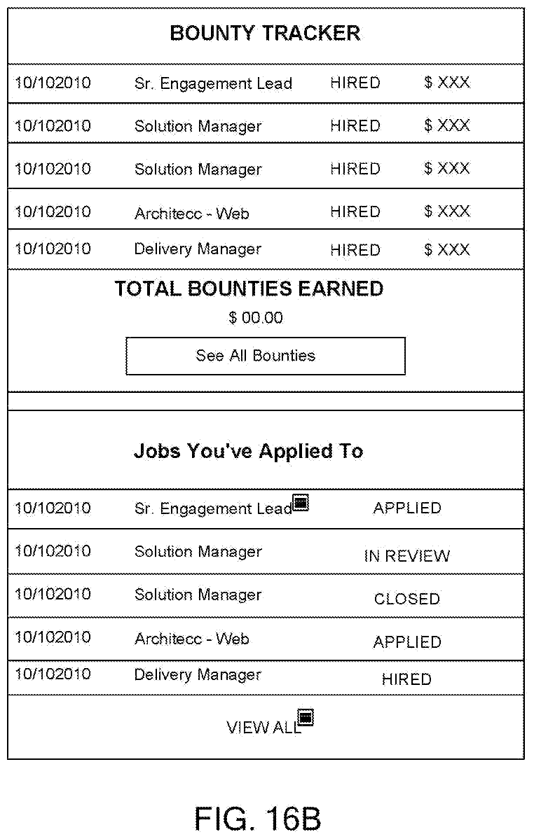

As shown in FIGS. 16A and 16B, a registered user can have the abilities of a job seeker, with the additional features of being able to apply for jobs and track the application progress as well as to collect bounties for jobs recommended to others, as discussed above.

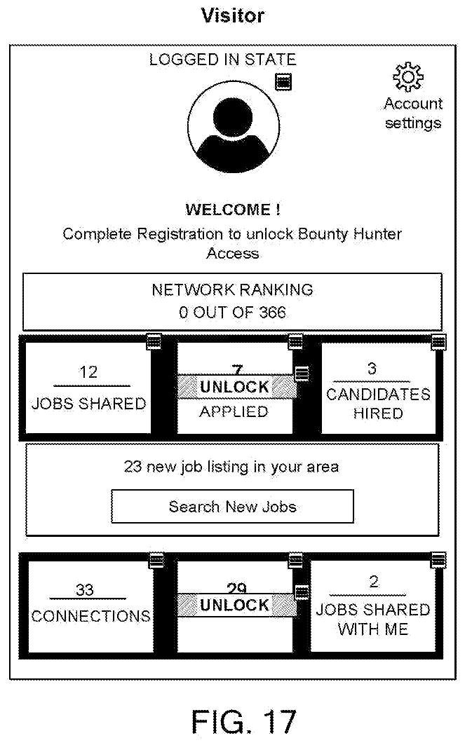

In some embodiments, “Visitor” access may be provided, as shown in FIG. 17, however, as a visitor, access would be limited, where such visitors may be able to view jobs but may not have access to apply for jobs, create a profile, make professional connections, receive shared jobs, promote jobs, or collect bounties.

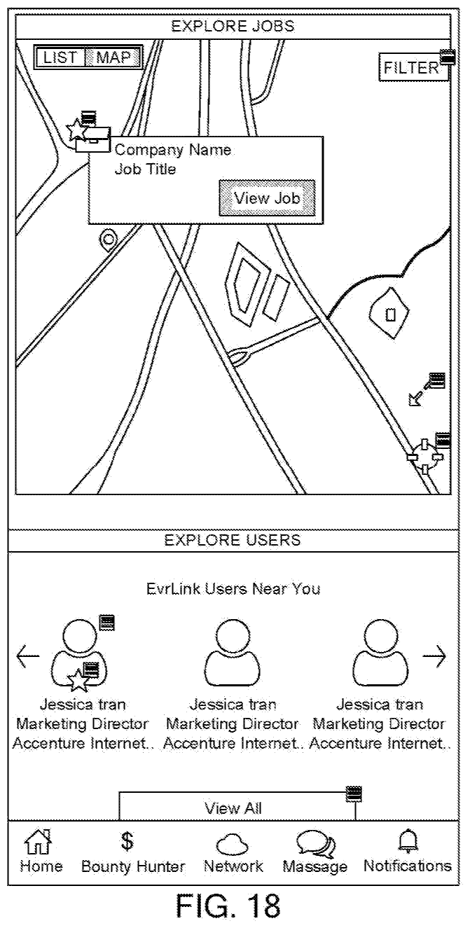

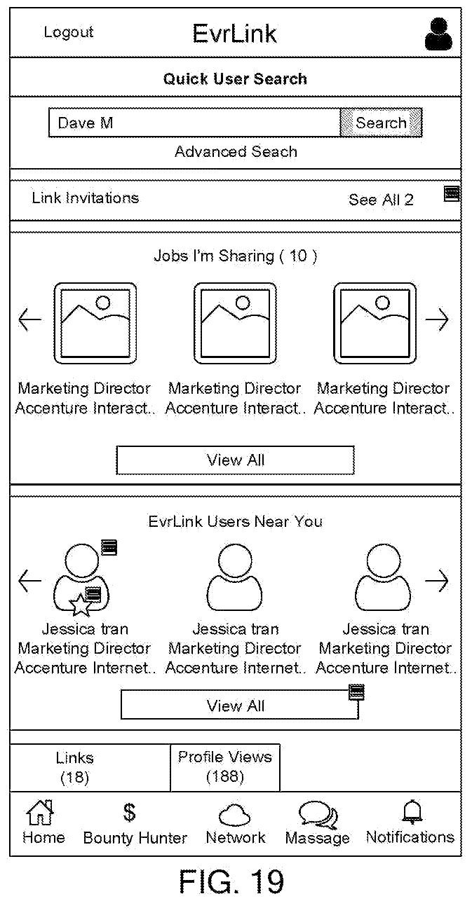

FIGS. 18 and 19 show exemplary screen shots available on a mobile application according to embodiments of the present invention. FIG. 18 shows a “Bounty Hunter” screen, accessible when the user taps the Bounty Hunter button at the bottom of the page. Here, a user can view jobs that may be promotable by them to others to earn a bounty. This page, like the map page described above, may include a map view, a list of users near the present user, and the like. FIG. 19 illustrates the “Network” page, where the user's network information may be shown, including invitations, jobs being shared, users near them, profile views, and the like.

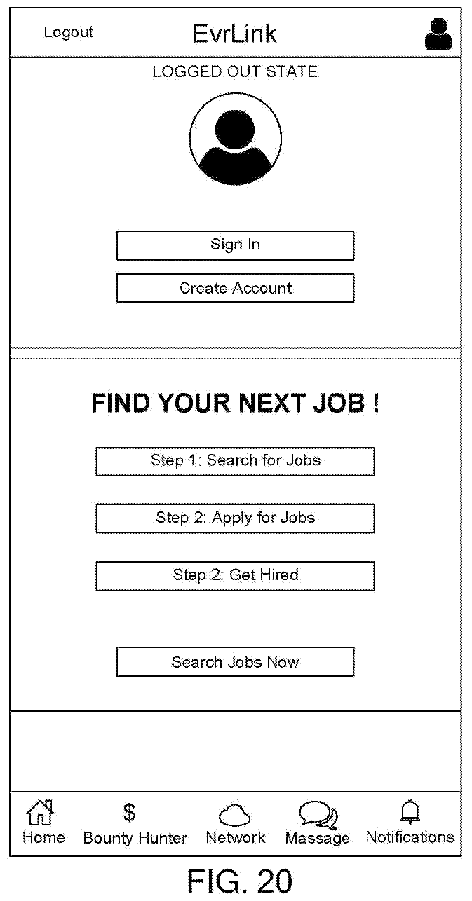

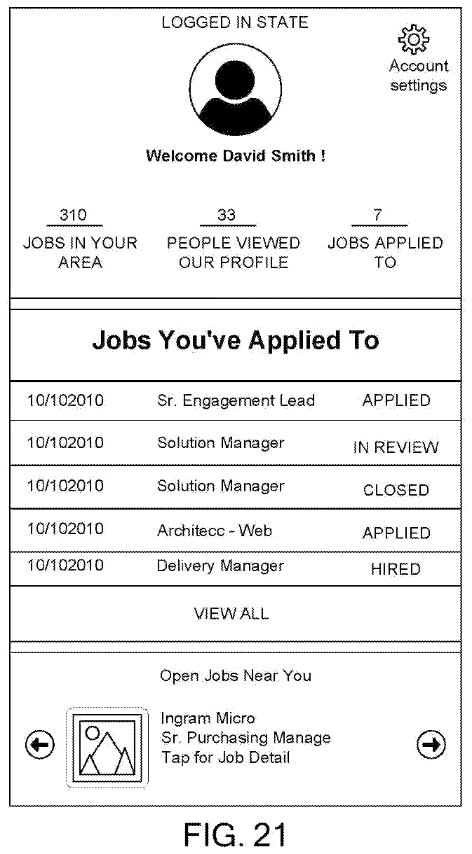

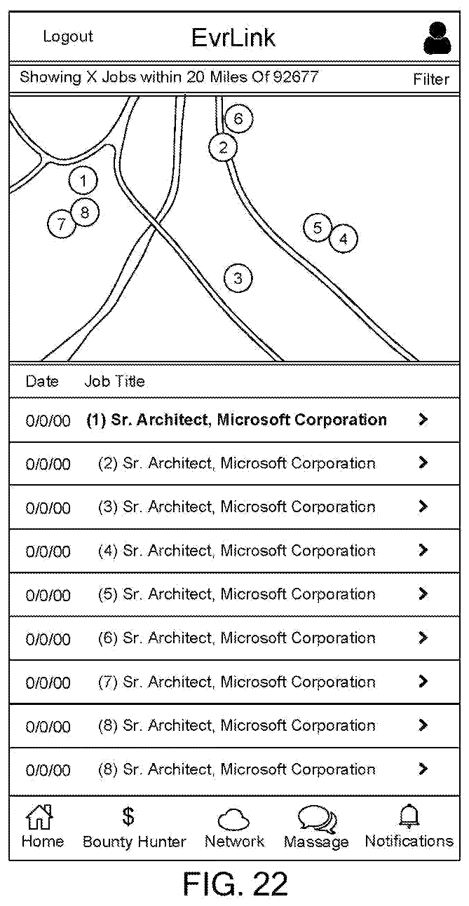

FIG. 20 shows a logged out state for a job seeker using the mobile application, while FIG. 21 shows a home screen once a job seeker signs in. This screen can include a summary of jobs applied to, jobs near the user, and people who viewed the user's profile, for example. If the user clicks to view all jobs, a screen similar to that of FIG. 22 an appear, showing the jobs available to the job seeker in a map view and a list view.

As discussed above, users will also be given individual web pages, sort of like a landing page, where they can display their public profile, including sponsored jobs, links to their social media profiles, and other customized content. Users with many followers and connections can also earn money by allowing employers, product manufacturers, or service providers to advertise on their individual profile pages.

Employers can offer incentives and rewards to showcase their jobs on users' public profiles. For example, an employer can offer a $100.00 to $1K reward or “bounty” to users when candidates are hired through their networks or their efforts. The bounty offered by the user can be shared by the application developer with its users that may promote the jobs or whose efforts otherwise find and cause a candidate to be hired. All the user has to do is upload and attach job descriptions or web links to these job descriptions and the users' network will be notified. Further, the job descriptions will follow the person wherever they go, enabling mobile advertising and recruiting to other users within a predefined radius of the user, regardless of whether these other users are in the user's network.

The application may further receive external job listings and post them to its network. For example, users can see jobs coming from ZipRecruiter on a map display, access them for more details and use the apply button to go to the original job posting and submit their applications or use the share button to share them with other potential candidates. Typically, in this embodiment, all job applications will be managed by the original job posters, not via the instant application. The application developers can receive revenue based on the total clicks that users of the application make on external jobs, such as ZipRecruiter jobs. Each click has a different bid associated with it and the external job site can share a portion of that bid value with the application developer. Based on the job and the bid associated with the external jobs, the application developer may share this revenue with other users who promote external jobs via their application profile. Thus, a user can promote “internal” jobs, which are posted directly to the application by employers, to earn bounties, or the user can promote “external” jobs, to potentially earn revenue based on a shared click-through payment received by the application developer.

In still other embodiments, employers can also offer nominal rewards ($0.10-$0.50) for each click on or view of the job description with posted directly with the application (so-called, internal job postings) because such clicks generate traffic to their job descriptions and website.

Power networkers or users with robust professional networks can charge a premium to post employer jobs because employers will want visibility to either their large network or specialized talent. Currently, millions of professionals have amassed large networks and followers; however, they have struggled to monetize their connections and professional relationships. This mobile software application gives them a platform from which to connect with, engage and monetize their established and growing professional networks.

While not limited to any particular technology or platform, the server side API can use ASP.NET Core version 1.1, running on the full .NET Framework 4.6.1. The solution was developed with Visual Studio 2015 and then ported to Visual Studio 2017. The solution has six layers, uses a generic repository implementation and, as the backend, it uses Entity Framework Core, connecting to an SQL Server database. For the jobs that run in the background to send notifications to clients, a Windows Service has been implemented using Topshelf and Hangfire.

The iOS software application can be developed using Cocoa Touch framework inside Xcode IDE, both provided by Apple. The application has been written in Swift programming language, with the exception of several open source libraries written in Objective-C.

The software application can use Facebook SDK, LinkedIn SDK and Google SDK for connecting to social networks, Google Places API for retrieving places, Google Maps SDK for displaying and populate the users/jobs map, Firebase SDK for push notifications and crash reporting, and SignalR for live conversations in chat.

The Android app is developed using Android SDK features written using Android Studio IDE, both provided by Google. The app has been written in Java (Android specific) programming language. The software application can use Facebook SDK, LinkedIn SDK and Google SDK for connecting to social networks, Google Places API for retrieving places, Google Maps SDK for displaying and populate the users/jobs map, Firebase SDK for push notifications and crash reporting and SignalR for live conversations in chat.

Of course, other technologies and platforms may be used, depending on the particular user need and application.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense, it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for advertising a job opportunity, comprising:
populating a job database with the job opportunity;
associating the job opportunity to one or more job ambassadors;
tracking a location of a job seeker by geolocation of a job seeker mobile computing device;
displaying, via a mobile application stored on the job seeker mobile computing device, the job opportunity when the job opportunity is within a predefined distance from the job seeker; and
displaying, on the job seeker mobile computing device, other users of the mobile application who are within the predefined distance from the job seeker;
permitting the job seeker to recommend the job opportunity to other professionals using the mobile application and networked with the job seeker on the mobile application;
permitting the job seeker to recommend the job opportunity to other professionals using the mobile application and within a predefined distance of the job seeker;
displaying a bounty associated with each job opportunity; and
paying the bounty to the job seeker when the other professionals, with which the job opportunity is shared, applies for the job opportunity and is hired.

2. The method of claim 1, wherein the displaying of the job opportunity is selectable between a list view and a map view.

3. The method of claim 2, wherein the map view on the job seeker mobile computing device provides a location of the one or more job ambassadors.

4. The method of claim 1, further comprising recommending another user for the job opportunity.

5. The method of claim 4, wherein the other user is linked to the job seeker via a network of the job seeker.

6. The method of claim 1, further comprising displaying, on the mobile computing device of the job seeker, job opportunities recommended by the job seeker to the other professionals.

7. The method of claim 6, wherein the display of the job opportunities recommended by the job seeker to the other professionals includes a status of progress of each of the other professional toward the job opportunities, wherein the progress includes an indication that the other professional applied for the job opportunity and an indication that the other professional is hired for the job opportunity.

8. The method of claim 1, further comprising displaying, on the mobile computing device of the user, the bounty due to be paid to the user.

9. The method of claim 1, further comprising:
associating resume information with a profile of the job seeker; and
broadcasting the resume information for access by the one or more brand ambassadors within the predefined distance.

10. The method of claim 1, further comprising:
broadcasting the job opportunity from the mobile computing device of the user to other users linked to the profile of the user.

11. The method of claim 1, further comprising:
associating, by the job seeker, the job opportunity with a profile of the job seeker, thus causing the job seeker to become one a job promoter associated with the job opportunity;
permitting other professionals networked with the job seeker to view the job opportunity via the profile of the job seeker and apply to the job opportunity via the profile of the job seeker; and
paying the bounty to the job seeker with the other professionals apply to the job opportunity via the profile of the job seeker and is hired.

12. The method of claim 1, further comprising permitting the job seeker to share the job opportunity with an external social media site associated with the job seeker.

13. A method for linking recruiters and job seekers, comprising:
tracking a first location of the one or more job seekers of a mobile application by geolocation of a job seeker mobile computing device of each of the one or more job seekers;
providing a map view on the job seeker mobile computing device, the map view providing a location of one or more job opportunities;
notifying the job seeker of the one or more job opportunities within a predefined distance;
associating, by the job seeker, the job opportunity with a profile of the job seeker, thus causing the job seeker to become a job promoter associated with the job opportunity;
permitting other professionals networked with the job seeker to view the job opportunity via the profile of the job seeker;
permitting other users to view the job opportunity via the profile of the job seeker when the job seeker is within a second predefined distance;
permitting the job seeker, the other professionals networked with the job seeker or the other users to apply for the job opportunity;
providing a first bounty payment to the job seeker when the other professionals view the job opportunity via the profile of the job seeker, apply to the job via the profile of the job seeker, and is hired; and
providing a second bounty payment to a user of the mobile application when the user recommends the one or more job seekers to one of the one or more job opportunities and the one or more job seekers is hired.

14. The method of claim 13, wherein the user is one of the one or more job ambassadors or one of the one or more job seekers.

15. The method of claim 13, further comprising:
associating resume information with a profile of the job seeker; and
broadcasting the resume information for access by the one or more recruiters within the predefined distance.

16. A method for advertising a job opportunity, comprising:
populating a job database with the job opportunity, the job opportunity including at least one of an internal job opportunity, posted by an employer directly to a job seeker using a mobile application, and an external job opportunity, posted by the employer to a job site external to the mobile application;
tracking a location of a job seeker by geolocation of a job seeker mobile computing device;
displaying, via the mobile application stored on the job seeker mobile computing device, the job opportunity when the job opportunity is within a predefined distance from the job seeker; and
displaying, on the job seeker mobile computing device, other users of the mobile application who are within the predefined distance from the job seeker;
permitting the job seeker to recommend the job opportunity to the other users within the predefined distance or to other professionals using the mobile application and networked with the job seeker on the mobile application;
displaying a first bounty associated with each internal job opportunity;
paying the first bounty to the job seeker when the other professionals, with which the internal job opportunity is shared, applies for the internal job opportunity and is hired; and
paying a second bounty to a mobile application provider when a job seeker or the other professionals click into the external job opportunity.

17. The method of claim 16, further comprising linking the job seeker, or other professionals recommended by the job seeker, to a site associated with the external job opportunity when the job seeker, or other professionals recommended by the job seeker, click into the external job opportunity.

18. The method of claim 16, further comprising sharing the second bounty with the job seeker when the job seeker recommends the other professionals for the external job opportunity and the other professionals click into the external job opportunity.
